(19) United States
(12) Patent Application Publication
(10) Pub. No.: US 2025/0340244 A1
(43) Pub. Date: Nov. 6, 2025

(54) BATTERY POD FOR A VOCATIONAL VEHICLE

(71) Applicant: Oshkosh Corporation, Oshkosh, WI (US)

(72) Inventor: Mitchell Murphy, Oshkosh, WI (US)

(73) Assignee: Oshkosh Corporation, Oshkosh, WI (US)

(21) Appl. No.: 19/197,056

(22) Filed: May 2, 2025

Related U.S. Application Data
(60) Provisional application No. 63/642,397, filed on May 3, 2024.

(51) Int. Cl. B62D 21/15; B60L 53/80

(52) U.S. Cl. CPC B62D 21/155; B60L 53/80; B60L 2200/40

(57) ABSTRACT

A vocational vehicle includes a chassis, a vehicle body, and a battery pod. The chassis supports a plurality of tractive elements. The vehicle body is coupled to the chassis and includes an application kit having at least one component that is movable relative to the chassis. The battery pod is detachably coupled to the chassis and is configured to provide power to at least one of the plurality of tractive elements or the application kit. The battery pod includes a shell, a plurality of battery strings, and a plurality of access panels. The battery strings are disposed within an interior cavity of the shell and each include a battery disconnect. The plurality of access panels are detachably coupled to the shell and provide access to respective ones of the plurality of battery disconnects.

### CROSS-REFERENCE TO RELATED APPLICATIONS

This application claims the benefit of and priority to U.S. Provisional Patent Application No. 63/642,397, filed May 3, 2024, the entire contents of which are hereby incorporated by reference herein.

### BACKGROUND

Electric vocational vehicles include a chassis and an electrical energy storage element (e.g., batteries, etc.) that supply energy to an electric motor to power vehicle operations. The vocational vehicle may also include specialized equipment that is tailored for specific applications. For example, a refuse vehicle may include a vehicle body that includes a lift system to engage and discharge the contents of a refuse container into the vehicle body, whereas a mixer truck may include a drum system to rotate a concrete mixing drum that is coupled to a vehicle chassis.

### SUMMARY

One embodiment relates to a vocational vehicle including a chassis, a vehicle body, and a battery pod. The chassis supports a plurality of tractive elements. The vehicle body is coupled to the chassis and includes an application kit having a component that is movable relative to the chassis. The battery pod is detachably coupled to the chassis and is configured to provide power to at least one of the plurality of tractive elements or the application kit. The battery pod includes a shell, a plurality of battery strings, and a plurality of access panels. The shell defines an interior cavity. The plurality of batteries strings is disposed within the interior cavity. The battery strings each include: a plurality of batteries that are electrically coupled to one another; and a battery disconnect coupling the plurality of batteries to the at least one of the plurality of tractive elements or the application kit. The access panels are detachably coupled to the shell and provide access to respective ones of the battery disconnects.

Another embodiment relates to a battery pod including a shell, a plurality of battery strings, and a plurality of access panels. The shell defines an interior cavity and a pair of recessed channels extending in a longitudinal direction. The pair of recessed channels is sized to receive a pair of frame rails of a vehicle chassis. The plurality of batteries strings is disposed within the interior cavity and extends along the longitudinal direction. The battery strings each include a plurality of batteries that are electrically coupled to one another; and a battery disconnect electrically coupled to plurality of batteries. The access panels are detachably coupled to the shell and provide access to respective ones of the battery disconnects.

Another embodiment relates to a method of servicing a battery pod for a vocational vehicle. The method includes: accessing a plurality of battery disconnects for a plurality of battery strings by removing a plurality of access panels from ends of respective ones of the plurality of battery strings, where the battery strings each including a plurality of batteries that are electrically coupled to one another; electrically decoupling the battery strings from the vocational vehicle at the battery disconnects; and decoupling the battery pod from the vocational vehicle.

Another embodiment relates to a vocational vehicle including a chassis, a vehicle body, and a battery pod. The chassis supports a plurality of tractive elements. The vehicle body is coupled to the chassis and includes an application kit having at least one component that is movable relative to the chassis. The battery pod is detachably coupled to the chassis and is configured to provide power to at least one of the plurality of tractive elements or the application kit. The battery pod includes a shell, a plurality of batteries, and a plurality of access panels. The shell defines an interior cavity. The batteries are disposed within the interior cavity and include a plurality of battery disconnects. The plurality of access panels are detachably coupled to the shell and provide access to the plurality of battery disconnects.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a vocational vehicle, according to an exemplary embodiment;

FIG. 2 is a perspective view of a front-loading refuse vehicle, according to an exemplary embodiment;

FIG. 3 is a side view of a side-loading refuse vehicle, according to an exemplary embodiment;

FIG. 4 is a right-side perspective view of a chassis for a vocational vehicle that includes a removable battery pod, according to an exemplary embodiment;

FIG. 5 is a left side perspective view of the chassis and battery pod of FIG. 4;

FIG. 6 is a bottom perspective view of the chassis and battery pod of FIG. 4;

FIG. 7 is a perspective view of a base structure of the battery pod of FIG. 4, according to an exemplary embodiment;

FIG. 8 is a perspective view of a mid-plate structure of the battery pod of FIG. 4, shown assembled to the base structure of FIG. 7, according to an exemplary embodiment;

FIG. 9 is a perspective view of the mid-plate structure of FIG. 8 with sub-frame mount elements attached to the mid-plate structure, according to an exemplary embodiment;

FIG. 10 is a perspective view of the mid-plate structure of FIG. 9 including a sub-frame attached to the sub-frame mount elements, according to an exemplary embodiment;

FIG. 11 is a perspective view of the battery pod of FIG. 4 including battery cover panels installed over batteries within the battery bod, according to an exemplary embodiment;

FIG. 12 is a perspective view of the battery pod of FIG. 4 including side panel covers defining a step, according to an exemplary embodiment;

FIG. 13 is a perspective view of the battery pod of FIG. 12 including frame mount elements that are configured to couple the battery pod to a vehicle chassis, according to an exemplary embodiment;

FIG. 14 is a front perspective view of the battery pod and frame mount elements of FIG. 13;

FIG. 15 is a perspective view of one of the frame mount elements of FIG. 13, shown in a region to an outside of a frame rail of the chassis, according to an exemplary embodiment;

FIG. 16 is a perspective view of the frame mount element of FIG. 15, shown in a region to an inside of the frame rail, according to an exemplary embodiment;

FIG. 17 is a right-side perspective view of the battery pod of FIG. 12, shown with a side panel cover removed from the battery pod, according to an exemplary embodiment;

FIG. 18 is a front perspective view of the battery pod of FIG. 17 showing a conduit channel defined along a side of the battery pod, according to an exemplary embodiment;

FIG. 19 is a front perspective view of the battery pod of FIG. 12, showing a front access panel of the battery pod, according to an exemplary embodiment;

FIG. 20 is a front perspective view of the battery pod of FIG. 19 with the front access panel removed, according to an exemplary embodiment;

FIG. 21 is a front view of the battery pod of FIG. 12, shown with multiple front access panels removed from the battery pod, according to an exemplary embodiment;

FIG. 22 is a right-side perspective view of a chassis for a vocational vehicle that includes a battery pod, according to another exemplary embodiment;

FIG. 23 is a left side perspective view of the chassis and battery pod of FIG. 22;

FIG. 24 is a right-side perspective view of a chassis for a vocational vehicle that includes a battery pod, according to another exemplary embodiment;

FIG. 25 is a left side perspective view of the chassis and battery pod of FIG. 24;

FIG. 26 is a right-side perspective view of a chassis for a vocational vehicle that includes a battery pod, according to another exemplary embodiment;

FIG. 27 is a left side perspective view of the chassis and battery pod of FIG. 26; and

FIG. 28 is a flow diagram of a method of servicing a battery pod for a vocational vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the figures, systems and methods of supporting a battery system onboard a vocational vehicle are shown, according to various exemplary embodiments. In some embodiments, the vocational vehicle includes a battery pod (e.g., a battery box, a battery containment module, etc.) that is detachably coupled to a chassis of the vocational vehicle. In at least one embodiment, the battery pod is bolted onto the frame rails of the chassis between a front and rear axle of the vehicle. The battery pod is configured to store multiple batteries in a single location along the vocational vehicle.

According to an exemplary embodiment, the battery pod includes access panels (e.g., covers, etc.) to facilitate access to the batteries, connections, and/or routings (e.g., high voltage cables, low voltage cables, cooling lines, etc.) for the battery system that is contained within the battery pod. According to an exemplary embodiment, the access panels are arranged to enable access to all of the battery disconnects within the battery pod without having to remove the battery pod from the chassis. The access panels also enable access to routings that connect batteries and/or cooling hardware at opposing ends of the battery pod, without having to remove the battery pod from the chassis. Such an arrangement can simplify assembly, repair, and replacement of various components of the energy storage system without removing the entire battery pod. Such an arrangement can also enable assembly of the battery system separately from the vehicle (e.g., off vehicle) and installation as a complete module.

In at least one embodiment, the battery pod also forms part of the vehicle structure for the vocational vehicle. For example, the battery pod may include or define low pressure drop side guards that extend in a longitudinal direction between the front and the rear axle. The side guards may have a streamlined shape to reduce aerodynamic drag. The side guards may also define a step to allow an operator to step up onto the side guards to gain access to a vehicle body.

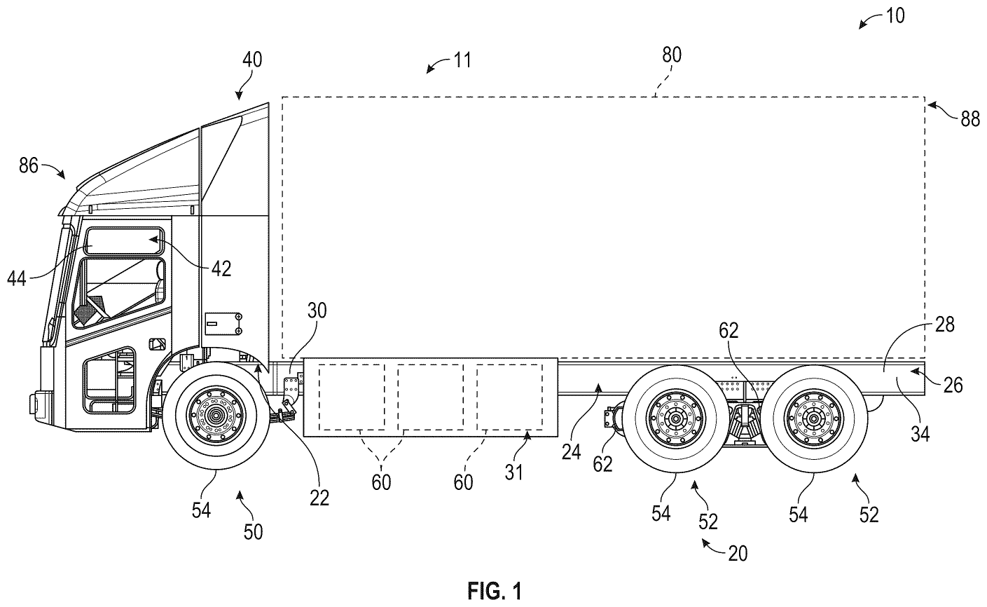

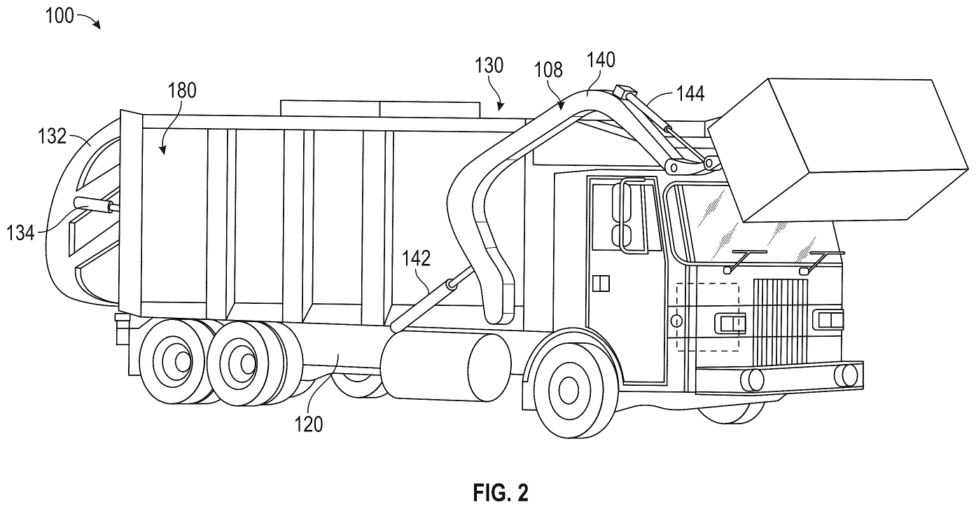

According to an exemplary embodiment, as shown in FIGS. 1 and 2, a vocational vehicle (e.g., a vehicle assembly, a truck, a vehicle base, etc.), shown as vehicle 10, includes a frame assembly or chassis assembly, shown as chassis 20. The chassis 20 may support other components of the vehicle 10. In some embodiments, the chassis 20 extends longitudinally along a length of the vehicle 10 between a front end and a rear end of the vehicle 10. The chassis 20 may extend substantially parallel to a primary direction of travel of the vehicle 10. According to an exemplary embodiment, the chassis 20 includes three sections or portions, shown as front section 22, middle section 24, and rear section 26. The middle section 24 of the chassis 20 extends between the front section 22 and the rear section 26.

The front section 22, the middle section 24, and the rear section 26 are defined by a pair of frame rails 28 that are spaced apart from one another along a lateral direction that is perpendicular to the longitudinal direction. The frame rails extend continuously along the entire length of the vehicle 10.

In some embodiments, the middle section 24 acts as a support portion that supports one or more vehicle components. The middle section 24 may be configured to support an enclosure (e.g., a battery pod, etc.) that contains one or more vehicle components (e.g., batteries, etc.) and/or a sub-frame that supports one or more vehicle components. In the embodiment of FIG. 1, the middle section 24 is directly coupled to and supports one or more electrical energy storage devices (e.g., batteries, capacitors, etc.), shown as a battery pod 31.

The vehicle 10 also includes a vehicle body 11 coupled to the chassis 20. According to an exemplary embodiment, a cabin, operator compartment, or a first body component of the vehicle body 11, shown as cab 40, is coupled to a front-end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42 that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. In one embodiment, the cab interior 42 contains components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

According to an exemplary embodiment, the vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. In one embodiment, the vehicle 10 includes a tag axle that may be raised or lowered to accommodate variations in weight being carried by the vehicle 10. The front axle 50 and the rear axles 52 each include a plurality of tractive elements (e.g., motive members, wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. As shown in FIG. 1, the vehicle 10 includes one or more electrical energy storage devices (e.g., batteries, capacitors, etc.), shown as batteries 60. As shown, the batteries 60 are positioned within the middle section 24 of the chassis 20 and within the battery pod 31.

The vehicle 10 further includes one or more electromagnetic devices (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 54 and provide electrical energy to the batteries 60, providing a braking force to slow the vehicle 10. As shown, the drive motors 62 are positioned within the rear axles 52 (e.g., as part of a combined axle and motor assembly). In other embodiments, the drive motors 62 are positioned in another axle of the vehicle 10, or are individual motors paired with individual wheel and tire assemblies 54.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system includes a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide the axle front axle 50 and/or the rear axles 52 to propel the vehicle 10. Additionally, or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 is further configured to support non-hybrid powertrains. For example, the powertrain system may include a primary driver that is a compression-ignition internal combustion engine that utilizes diesel fuel.

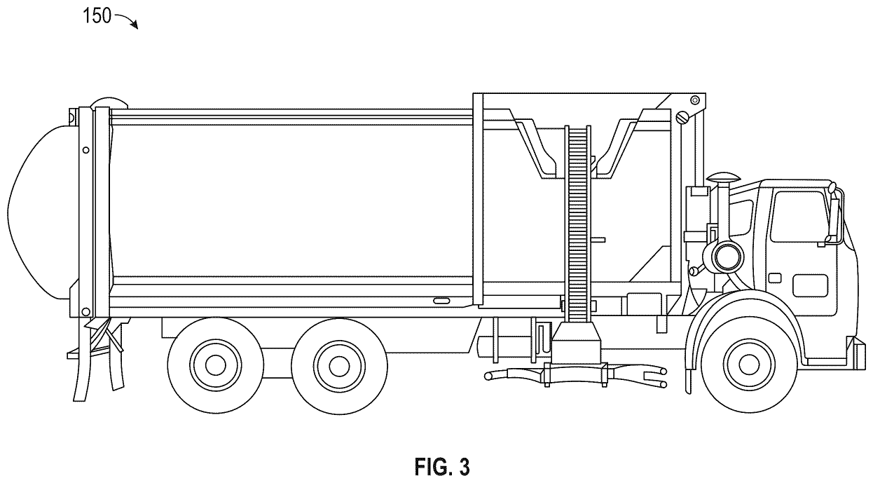

As shown in FIG. 1, the vehicle 10 (e.g., the vehicle body 11, etc.) includes a rear (e.g., a second, etc.) assembly, module, implement, body, component, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 2-3 illustrate various examples of how the vehicle 10 may be configured for specific applications. Although only a certain set of vehicle configurations is shown, it should be understood that the vehicle 10 may be configured for use in other applications that are not shown.

According to an exemplary embodiment, the application kit 80 includes various actuators to facilitate certain functions of the vehicle 10. In one embodiment, the application kit 80 includes hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. In another embodiment, the application kit 80 includes hydraulic or pneumatic components that form a hydraulic or pneumatic circuit (e.g., conduits, valves, pumps, compressors, gauges, reservoirs, accumulators, etc.). By way of another embodiment, the application kit 80 includes electrical components (e.g., batteries, capacitors, voltage regulators, motor controllers, etc.). The actuators may be powered by components of the vehicle 10. In some embodiments, the actuators are powered by the batteries 60, the drive motors 62, or the primary driver (e.g., through a power take-off).

Referring to FIG. 2, the vehicle may be configured as a refuse vehicle 100 (e.g., a refuse truck, a garbage truck, a waste collection truck, a sanitation truck, a recycling truck, etc.). In the embodiment of FIG. 2, the refuse vehicle 100 is a front-loading refuse vehicle configured to engage a refuse container at a front end of the refuse vehicle 100. Referring to FIG. 3, in other embodiments, the vocational vehicle may be a refuse vehicle 150 that is configured as a side-loading refuse vehicle. In other embodiments, the refuse vehicle may be configured as a rear-loading refuse vehicle.

Referring again to FIG. 2, the application kit 180 of the refuse vehicle 100 includes a rear body or container, shown as refuse compartment 130, and a pivotable rear portion, shown as tailgate 132. The refuse compartment 130 may facilitate transporting refuse from various waste receptacles within a municipality to a storage and/or a processing facility (e.g., a landfill, an incineration facility, a recycling facility, etc.). According to an exemplary embodiment, loose refuse is placed into the refuse compartment 130 to be compacted. The refuse compartment 130 may also provide temporary storage for refuse during transport to a waste disposal site and/or a recycling facility. In some embodiments, the refuse compartment 130 includes a hopper volume and storage volume. In this regard, refuse may be initially loaded into the hopper volume and later compacted into the storage volume. According to an exemplary embodiment, the hopper volume is positioned between the storage volume and the cab (e.g., refuse is loaded into a position of the refuse compartment 130 behind the cab \ and stored in a position further toward the rear of the refuse compartment 130). In other embodiments, the storage volume is positioned between the hopper volume and the cab (e.g., in a rear-loading refuse truck, etc.). The tailgate 132 may be pivotally coupled to the refuse compartment 130, and may be movable between a closed position and an open position by an actuator (e.g., a hydraulic cylinder, an electric linear actuator, etc.), shown as tailgate actuator 134 (e.g., to facilitate emptying the storage volume).

The refuse vehicle 100 also includes an implement, shown as lift assembly 108 (e.g., a front-loading lift assembly, etc.). According to an exemplary embodiment, the lift assembly 108 includes a pair of lift arms 140, lift arm actuators 142, and articulation actuators 144. The lift arms 140 may be rotatably coupled to the chassis 120. In another embodiment, the lift arms 140 are rotatably coupled to the refuse compartment 130 on each side of the refuse vehicle 100 (e.g., through a pivot, a lug, a shaft, etc.). Such an embodiment provides that the lift assembly 108 extends forward relative to the cab (e.g., a front-loading refuse truck, etc.). In other embodiments, the lift assembly 108 extends rearward relative to the application kit 180 (e.g., a rear-loading refuse truck). In yet other embodiments, the lift assembly 108 extends from a side of the application kit 180 (e.g., a side-loading refuse truck). In the embodiment of FIG. 2, the lift arm actuators 142 are positioned such that extension and retraction of the lift arm actuators 142 rotates the lift arms 140 about an axis extending through the pivot. In this regard, the lift arms 140 may be rotated by the lift arm actuators 142 to lift a refuse container over the cab. In an exemplary embodiment, the articulation actuators 144 are positioned to articulate the distal end of the lift arms 140 (e.g., a portion of the lift arms 140 that may be coupled to the refuse container) in order to assist in tipping refuse out of the refuse container and into the refuse compartment 130. The lift arm actuators 142 may then rotate the lift arms 140 to return the empty refuse container to the ground.

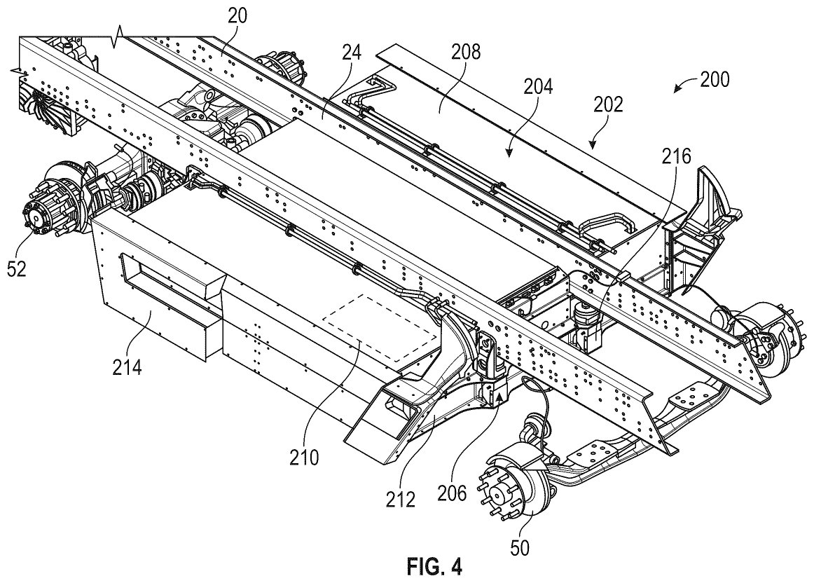

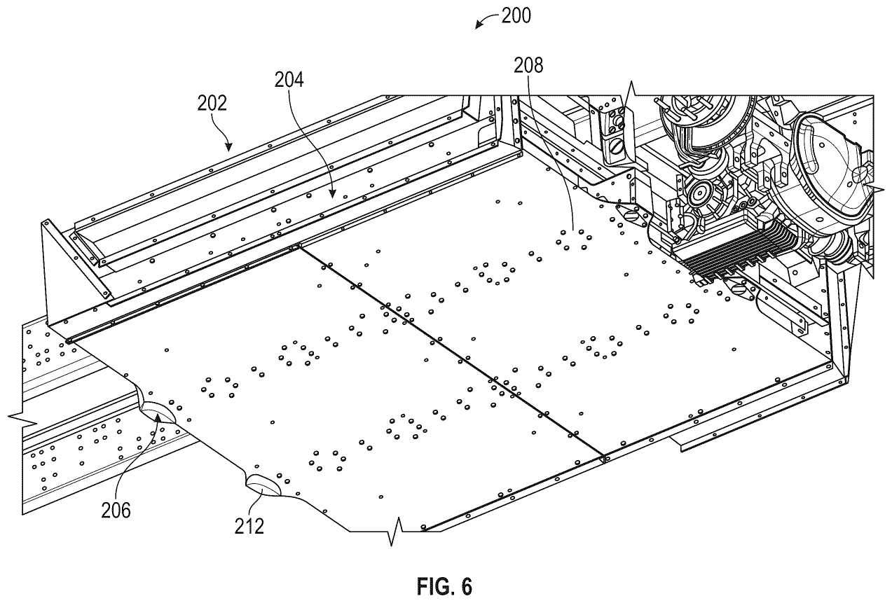

Referring to FIGS. 4-6, a battery containment structure, shown as battery pod 202 (e.g., a battery box, a battery containment module, etc.), supporting a battery system 200 on the chassis 20 is shown, according to an exemplary embodiment. The battery pod 202 is detachably coupled to the chassis 20, to the middle section 24 of the chassis 20, in a region that extends in a longitudinal direction between the front axle 50 and the rear axle 52. In the embodiment of FIGS. 4-6, the battery pod 202 is fastened to the chassis 20, to a pair of frame rails that are spaced apart from one another in a lateral direction that is normal to the longitudinal direction. The battery pod 202 is electrically coupled to the chassis 20 and/or the vehicle body 11 (see also FIG. 1) and is configured to supply electrical energy to the chassis 20 and/or the vehicle body 11 (e.g., to the application kit 80 of FIG. 1). For example, the battery pod 202 may be configured to provide power to drive at least one of the plurality of tractive elements and/or axles that are supported by the chassis 20 (e.g., the tire assemblies 54 of FIG. 1, etc.). The battery pod 202 may also be configured to supply electrical energy to power one or more components of an application kit (e.g., the application kit 80 of FIG. 1). For example, the battery pod 202 may be configured to supply electrical energy to power a lift assembly, a drum mixer, or another vehicle body actuator in other exemplary embodiments.

The battery pod 202 includes a housing assembly 204 including a support structure 206 and a shell 208; a plurality of batteries 210; a plurality of removable panels 212; and at least one side guard 214. In other embodiments, the battery pod 202 may include additional, fewer, and/or different components.

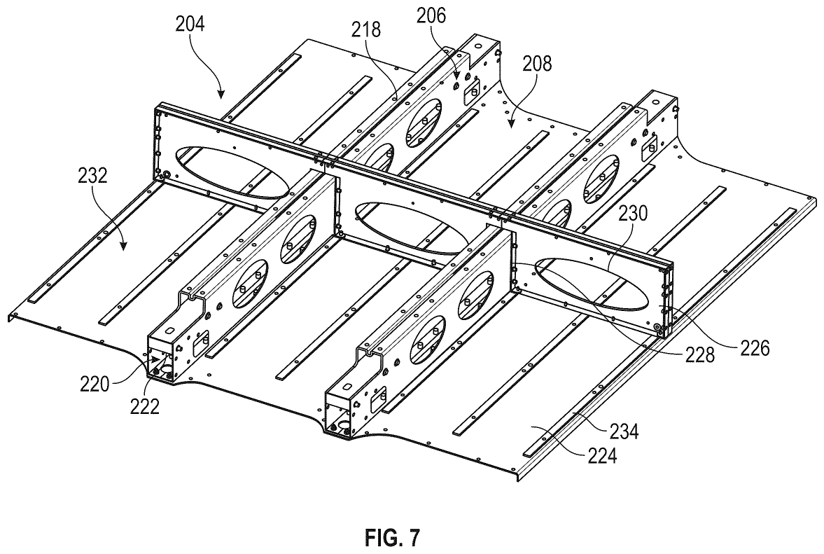

The housing assembly 204 is configured to contain various hardware of the battery system 200 and to support the battery system 200 on the chassis 20. The housing assembly 204 may be centered on the chassis 20 to improve weight distribution across the chassis 20 in the lateral direction. Referring to FIG. 7, the housing assembly includes the support structure 206 and the shell 208. The shell 208 includes a plurality of wall segments (e.g., wall panels, etc.) that enclose, support, and protect individual battery elements (e.g., batteries, battery modules, etc.). The support structure 206 includes at least one sub-frame 216 including a plurality of sub-frame members (e.g., sub-frame elements, a skeletal frame, etc.) to support wall segments of the shell 208.

Referring to FIG. 7, a first plurality of sub-frame members 218 of the support structure 206 are shown, according to an exemplary embodiment. The first plurality of sub-frame members 218 extend in the longitudinal direction and between opposing longitudinal ends of the housing assembly 204. In the embodiment of FIG. 7, the first plurality of sub-frame members 218 are sub-frame rails (e.g., frame rails, etc.) that extend parallel to one another. The sub-frame rails define rectangular shaped rail channels 220 (e.g., in a C-shape or U-shape with straight side walls that are oriented perpendicular to one another) facing along an axial direction that is normal to the longitudinal direction and the lateral direction. The rail channels 220 are configured to receive a pair of longitudinal supports 222 that are mounted to a base wall 224 of the shell 208, which can facilitate alignment between the base wall 224 and the support structure 206.

In the embodiment of FIG. 7, the support structure also includes a first frame partition 226 that is coupled to the first plurality of sub-frame members 218 and/or to the base wall 224. The first frame partition 226 nestably engages the first plurality of sub-frame members 218 at a plurality of frame channels 228 that extend through and are defined by the first frame partition 226. Together, the first frame partition 226, the base wall 224, and the first plurality of sub-frame members 218 define a first plurality of battery cavities 232a that are each sized to receive and support a battery (e.g., a battery module, etc.) therein. In the embodiment of FIG. 7, the first plurality of sub-frame members 218 defines six battery cavities 232a. In other embodiments, the number of battery cavities may be different.

In some embodiments, the first frame partition 226 also defines a plurality of pass-through openings 230 that extend therethrough and between adjacent ones of the plurality of battery cavities. The pass-through openings 230 may be configured to facilitate routings (e.g., electrical cables, fluid lines, etc.) between adjacent ones of the plurality of battery cavities along the longitudinal direction and/or airflow therethrough for a battery cooling system.

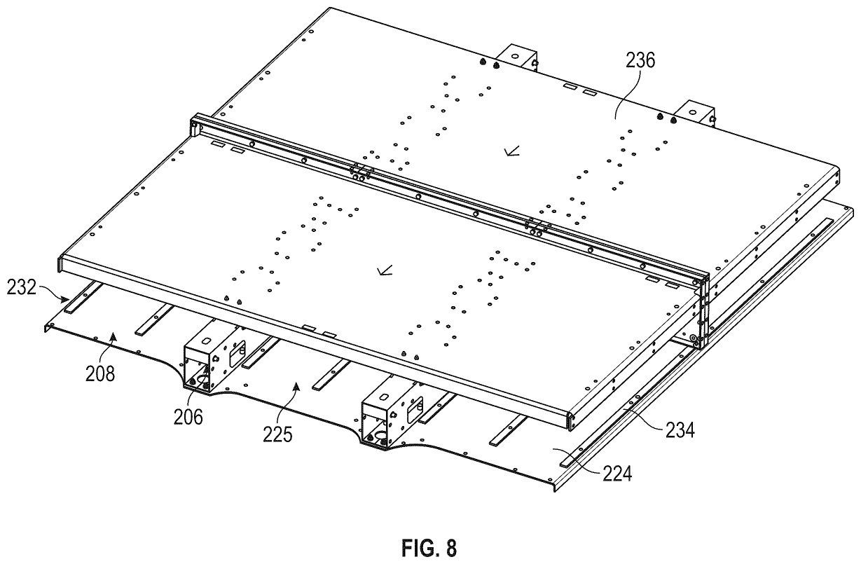

Referring to FIGS. 7-8, the shell 208 is configured to enclose openings defined by the support structure 206 and to separate (e.g., isolate, etc.) individual batteries (e.g., battery modules, etc.) from one another. The shell 208 includes the base wall 224 and may also include a plurality of side walls defining an interior cavity 225. The shell 208 may also include a plurality of battery mount elements 234 that are coupled to the base wall 224 to facilitate mounting of the batteries to the base wall 224. In the embodiment of FIGS. 7-8, the battery mount elements 234 are mounting strips that extend along the longitudinal direction. The mounting strips may be spaced apart from one another in approximately equal intervals along the width of the base wall 224. The mounting strips define fastener openings to which the batteries may be mounted to the base wall 224, and provide flexibility to enable mounting the batteries at different locations and/or with different arrangements of fasteners (e.g., bolts, screws, etc.) depending on application requirements. The mounting strips may be welded, glued, fastened, or otherwise coupled to the base wall 224. In other embodiments, the batteries may be directly fastened to the base wall 224.

Referring to FIG. 8, the shell 208 also includes a mid-plate 236 that is coupled to the first plurality of sub-frame members 218 and that extends across the first plurality of battery cavities 232a. The mid-plate 236 includes at least one wall panel that is fastened to the first plurality of sub-frame members 218, which can facilitate disassembly to access one or more of the batteries during servicing or maintenance events. In the embodiment of FIG. 8, the mid-plate 236 includes a pair of wall panels disposed on opposite sides of the first frame partition 226.

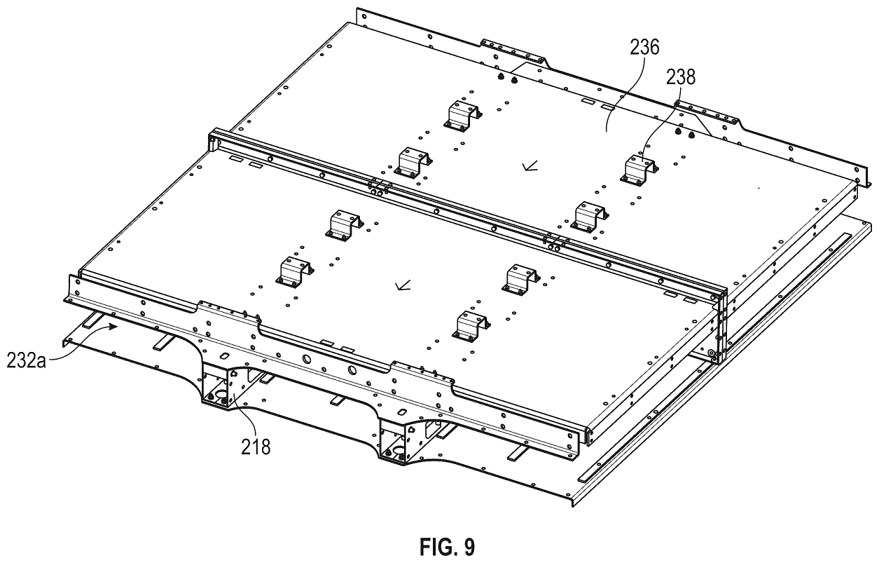

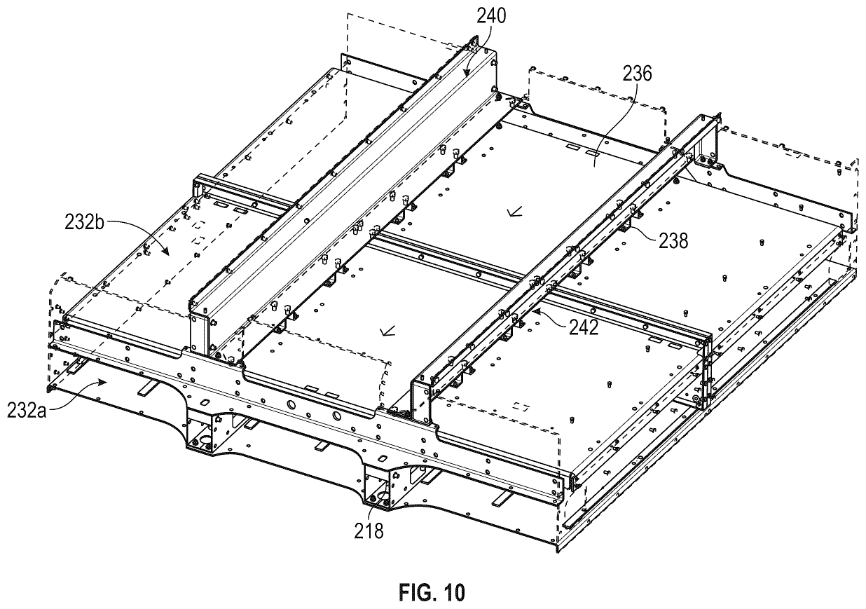

Referring to FIGS. 9-10, the mid-plate 236 may be configured to separate a first plurality of battery cavities (e.g., the battery cavities 232a, etc.) below the mid-plate 236 from a second plurality of battery cavities above the mid-plate 236. In such embodiments, the sub-frame structure may include a second plurality of sub-frame members 240 (e.g., sub-frame rails, etc.) above the mid-plate 236. The second plurality of sub-frame members 240 may the similar to the first plurality of sub-frame members 218.

In the embodiment of FIGS. 9-10, the sub-frame structure further includes a plurality of sub-frame mounts 238 that are configured to couple the mid-plate 236 to the second plurality of sub-frame members 240. The plurality of sub-frame mounts 238 may include brackets that are fastened to the mid-plate 236. Referring to FIG. 10, the sub-frame members 240 may define a second plurality of rail channels 242 that are sized to receive the plurality of sub-frame mounts 238, which can facilitate alignment between the second plurality of sub-frame members 240 and the mid-plate 236 along the lateral direction. The second plurality of sub-frame members 240 may be fastened (e.g., using bolts, screws, or another mechanical fastener) to the plurality of sub-frame mounts 238. Together, the second plurality of sub-frame members 240 and the mid-plate 236 define the second plurality of battery cavities 232b.

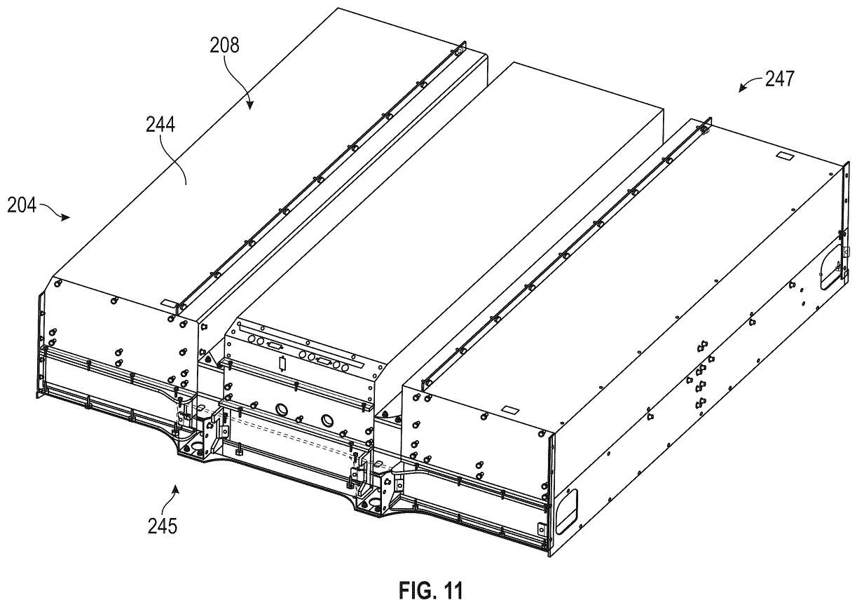

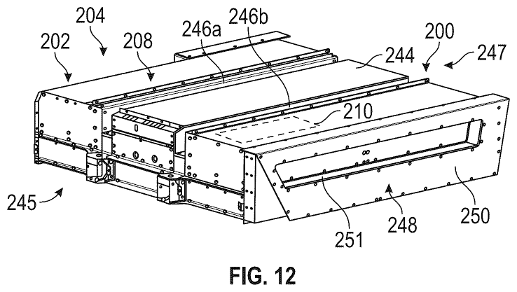

Referring to FIGS. 11-12, the shell 208 also includes a plurality of battery covers 244 (e.g., battery cover panels, battery lids, etc.) that are configured to substantially enclose (e.g., cover) the battery cavities and the batteries. In the embodiment of FIGS. 11-12, each of the battery covers 244 extends from a first longitudinal end 245 of the housing assembly 204 to a second longitudinal end 247 of the housing assembly 204. The battery covers 244 are rectangular shaped panels (e.g., U-shaped panels having straight sided perpendicular walls, etc.) that extend across, and cover, at least a pair of battery cavities. The battery covers 244 are fastened (e.g., using bolts, screws, or another mechanical fastener) to the sub-frame structure and/or the mid-plate 236 (see also FIG. 10). In other embodiments, the battery covers 244 are substantially planar wall panels that cover at least one side of the battery cavities, and may include a top wall panel, a side wall panel coupled to the top wall panel, etc. The shell 208 may also include seal members that engage the battery covers 244, the mid-plate 236, and/or another component of the battery pod that engages edges of the battery covers 244, along perimeter edges of the battery covers 244 to prevent water leakage into the housing assembly 204.

The batteries 210 (see FIG. 3) are disposed within the battery cavities and are covered by (e.g., enclosed within, etc.) the battery covers 244. In at least one embodiments, the batteries 210 are individual battery modules that are connected in series and/or in parallel depending on application requirements. In the embodiment of FIG. 12, the 12 batteries 210 are arranged in three battery strings (e.g., a left string, a right string, and a center string, etc.), where each string includes four batteries 210 connected in series to one another. In other embodiments, the arrangement of the batteries 210 may be different. Among other benefits, the arrangement of batteries 210 in the battery pod 202 simplifies operations required to disconnect the batteries 210 and/or strings from the vehicle, as will be further described.

In some embodiments, at least one of the battery covers 244 and the sub-frame members (e.g., the second plurality of sub-frame members 240 as shown in FIG. 10) together define a recessed channel (e.g., a recessed area, a groove, etc.) that is sized to receive a frame rail of a vehicle chassis therein. In the embodiment of FIG. 12, the housing assembly 204 defines a pair of recessed channels, shown as a first recessed channel 246a and a second recessed channel 246b. The first recessed channel 246a and the second recessed channel 246b may define installation guides that are each sized to receive a respective one of the pair of frame rails of the chassis therein. Such geometry can facilitate alignment of the battery pod 202 with respect to the chassis, and can improve structural support. Such geometry can also reduce the space claim along the vehicle and improve aerodynamic performance by positioning at least a portion of the battery pod 202 (e.g., the housing assembly 204) in between the frame rails of the chassis.

Referring to FIG. 12, the housing assembly 204 also includes a side guard 248 coupled to the shell 208. The side guard 248 is configured to improve aerodynamic performance. The side guard 248 is also configured to facilitate operator access to different parts of the vehicle. In the embodiment of FIG. 12, the side guard 248 is fastened to the shell 208 (e.g., using bolts, screws, or another type of mechanical fastener). In at least one embodiment, the side guard 248 includes a removable side panel 250 that is configured to facilitate access to routings for the battery system 200, such as high voltage cables, low voltage cables, and/or cooling lines (e.g., cooling conduit, etc.) and/or connections between the routings and the rest of the battery system 200, as will be further described.

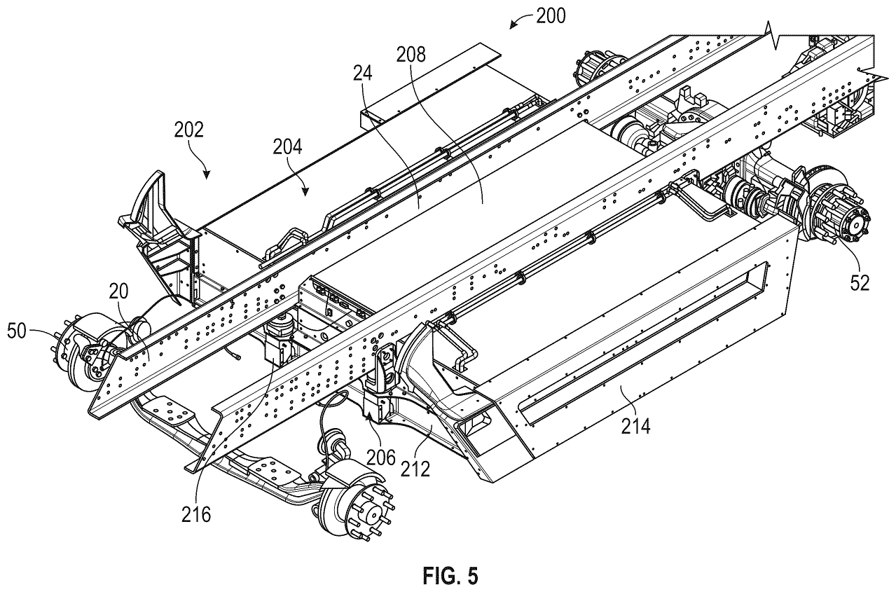

In some embodiments, the side guard 248 is a low pressure drop side guard that is configured to reduce drag on the battery pod and the vehicle during transit operations. In the embodiment of FIG. 12 (see also FIGS. 4-5), a forward end of the side guard 248 is tapered so that an upper end of the side guard 248 protrudes farther toward the front of the vehicle than a lower end of the side guard 248.

Referring still to FIG. 12, the side guard 248 also defines a step 251 (e.g., a ledge, a recessed area, etc.) that is configured to facilitate operator access to different parts of the vehicle. The step 251 defines an elongated recessed area (e.g., a channel, a slot, etc.) that extends along the longitudinal direction. Such an arrangement can facilitate access to the vehicle body or to a region between the cab and a rear body of the vehicle, according to various embodiments.

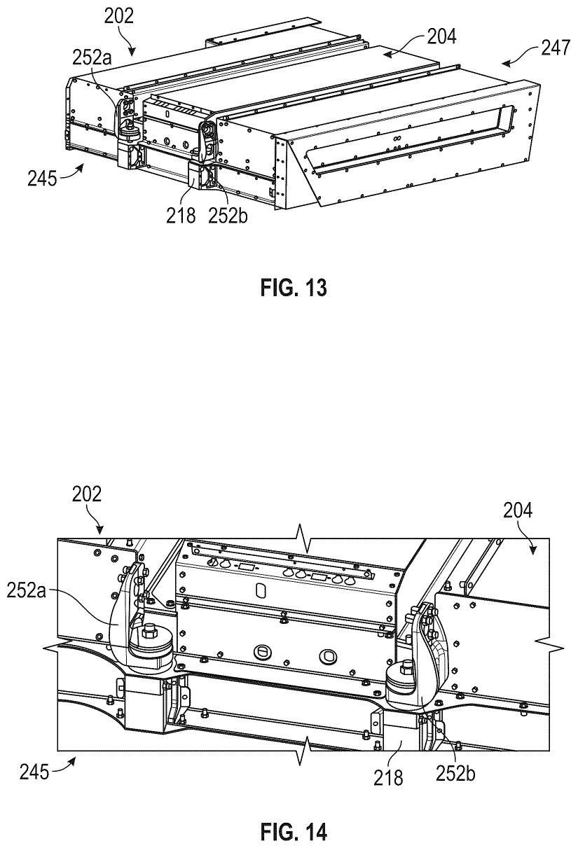

Referring to FIGS. 13-14, the battery pod 202 also includes frame mount elements that are configured to couple the battery pod 202 to the chassis. In some embodiments, the battery pod 202 includes a four-point mounting system that are directly fastened to the chassis in at least four distinct locations along the chassis (e.g., via bolts, screws, or another mechanical fastener). In some embodiments, the frame mount elements are arranged in two diametrically opposed pairs at the first longitudinal end 245 and the second longitudinal end 247 of the housing assembly 204. In the embodiment of FIGS. 13-14, each of the frame mount elements, shown as a first mount element 252a and a second mount element 252b are L-shaped flanges. The first mount element 252a and the second mount element 252b are arranged symmetric to one another about a reference plane that extends parallel to the longitudinal direction between a forward end and a rear end of the vehicle.

The first mount element 252a and the second mount element 252b are configured to couple a respective one of the first plurality of sub-frame members 218 and/or the second plurality of the sub-frame members 240 (see FIG. 8) to a respective one of the frame rails of the chassis. In some embodiments, the battery pod 202 also includes vibration isolators (e.g., grommets, pads, etc.) disposed between the frame elements and the housing assembly 204 (e.g., the second plurality of sub-frame members 240), and/or between the frame elements and a nut, which can dampen and/or isolate the housing assembly 204 from any vibrational forces transferred to the chassis.

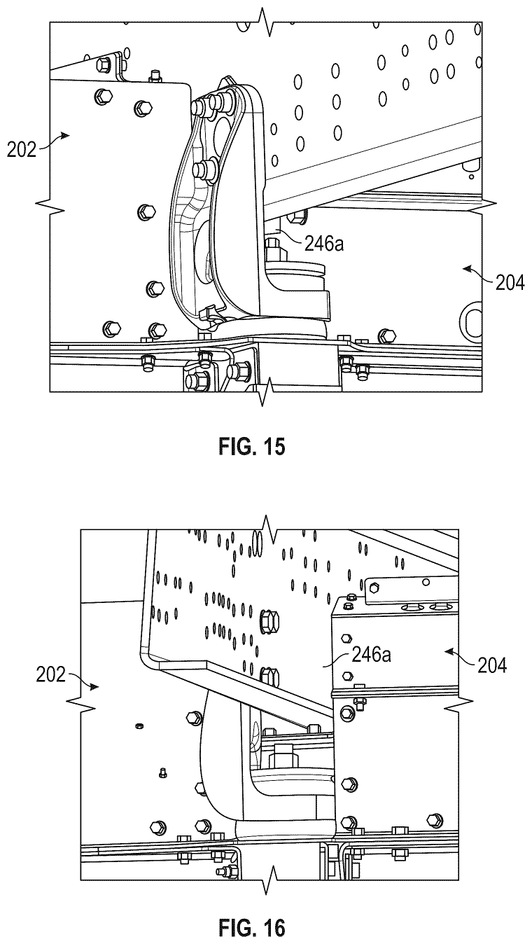

Referring to FIGS. 15-16, the housing assembly 204 is configured to nestably engage the chassis (e.g., the pair of frame rails, etc.) at the first recessed channel 246a and the second recessed channel 246b (see also FIG. 14) in an underswung mounting arrangement so that the battery pod 202 is supported beneath and in between the chassis frame rails. The first mount element 252a and the second mount element 252b are fastened to the first plurality of sub-frame members 240 along a longitudinal end portion of the first plurality of sub-frame members 240 that protrude beyond a longitudinal end of the shell 208. In such implementations, the battery pod 202 is fastened to the chassis (e.g., the frame rails) outside of the first recessed channel 246a and the second recessed channel 246b.

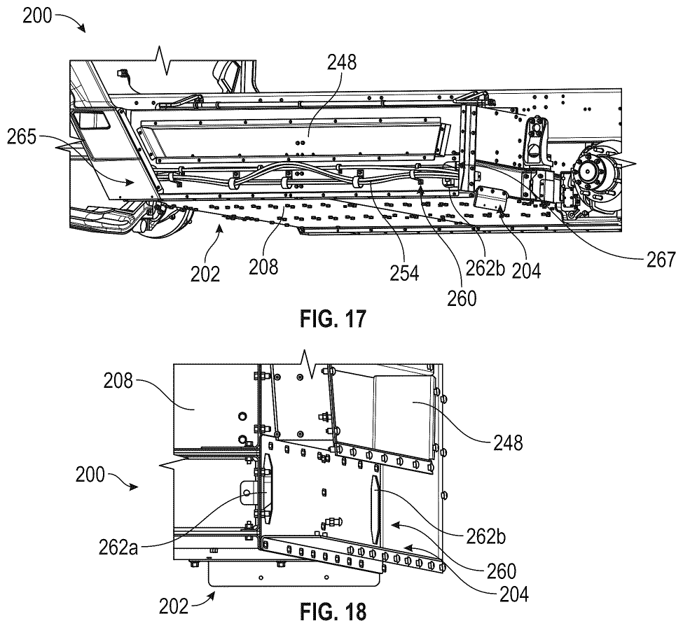

Referring to FIG. 17, the battery pod 202 is configured to facilitate access to connective hardware and/or routings 254 that extend between different portions of the battery system 200. The routings 254 may include high voltage cable, low voltage cable, coolant lines, and/or a combination thereof. For example, in some embodiments, the side guard 248 includes a removable side panel 250 (see FIG. 12) that is configured to facilitate access to a bundle of routings 254 that extend from the first longitudinal end 245 to the second longitudinal end 247 of the housing assembly 204. The side panel 250 is coupled to the shell 208 along at least a portion of the perimeter of the side panel 250 using fasteners (e.g., bolts, screws, or another mechanical fastener). Together, the side panel 250 and the shell 208 define a conduit channel 260 (e.g., a routing channel, etc.) extending in the longitudinal direction between opposing ends of the shell 208. In the embodiment of FIGS. 17-18, the conduit channel 260 extends in a region beneath the step. In other embodiments, the conduit channel 260 is positioned in another location along a lateral side of the housing assembly 204.

The shell 208 defines a plurality of access openings, shown as a first access opening 262a and a second access opening 262b, that are configured to provide access to the interior cavity from the conduit channel 260. In the embodiment of FIGS. 17-18, the first access opening 262a and the second access opening 262b extend through an exterior wall of the shell 208, from the conduit channel 260 to the interior cavity. The first access opening 262a is disposed proximate to a first longitudinal end 265 of the conduit channel 260, and the second access opening 262b is disposed proximate to a second longitudinal end 267 of the conduit channel 260 opposite from the first longitudinal end 262.

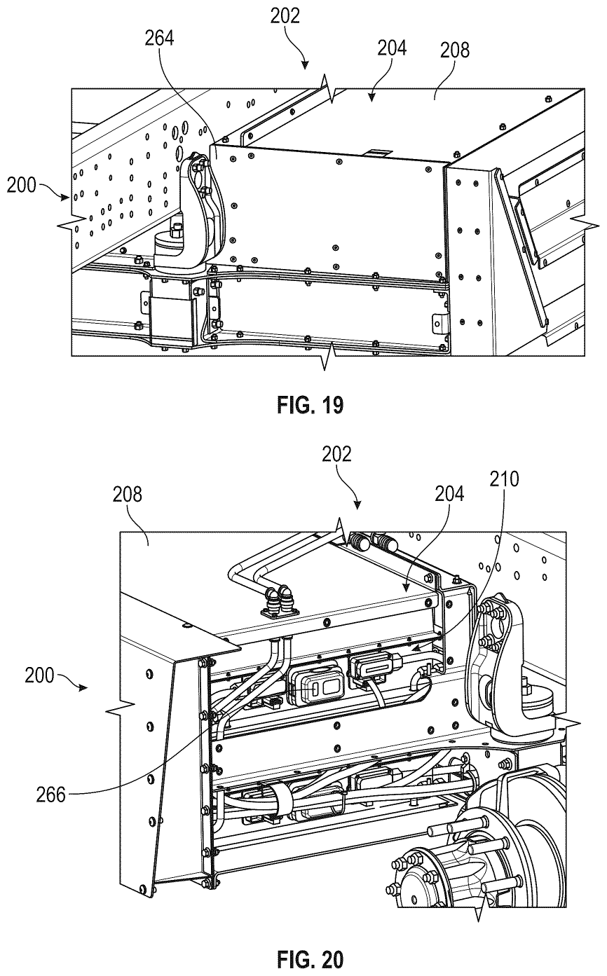

The battery pod 202 may also be configured to facilitate access to one or more electrical disconnects and/or fluid disconnects for the battery system 200. For example, referring to FIGS. 19-20, the battery pod 202 includes a plurality of removable panels, shown as access panels 264 that are detachably coupled to the shell 208 and that are configured to provide access to a plurality of battery disconnects 266 disposed within the interior cavity. The battery disconnects 266 may be electrical disconnects that are configured to decouple the batteries 210 from the vehicle body and/or the vehicle chassis (e.g., from a motor powering operation of the plurality of tractive elements and/or the application kit). In some embodiments, each battery string includes its own individual or set of battery disconnects 266 that is/are configured to electrically couple the respective battery string to the vehicle body and/or the vehicle chassis. In such embodiments, the battery disconnect(s) 266 for a first string of the plurality of battery strings may be configured to electrically couple the first string to at least one of the plurality of tractive elements or the application kit separately from the remaining battery strings.

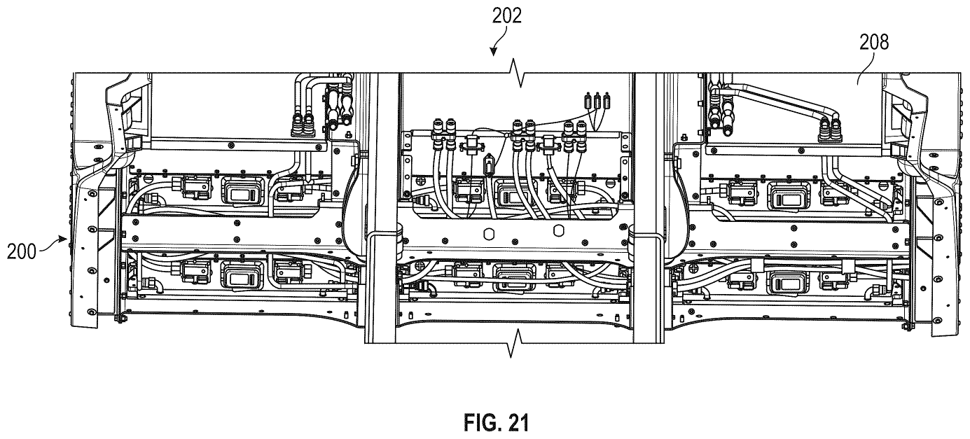

In some embodiments, a first set of the plurality of access panels 264 are disposed at a front end (e.g., a first longitudinal end, etc.) of the shell 208 and a second set of the plurality of access panels 264 are disposed at a rear end (e.g., a second longitudinal end, etc.) of the shell 208. The plurality of access panels 264 are each oriented normal to the longitudinal direction and are configured to provide access to the interior cavity through a respective one of the longitudinal ends of the housing assembly 204. In some embodiments, the access panels 264 are spaced laterally apart from one another by the recessed channels (e.g., the first recessed channel 246a and the second recessed channel 246b of FIG. 12). Referring to FIG. 21, in some embodiments, the battery pod 202 includes a separate access panel 264 (see also FIG. 19) for each battery cavity, each access panel 264 arranged to access battery disconnects for each of the batteries 210. In other embodiments, the arrangement of the access panels 264 may be different.

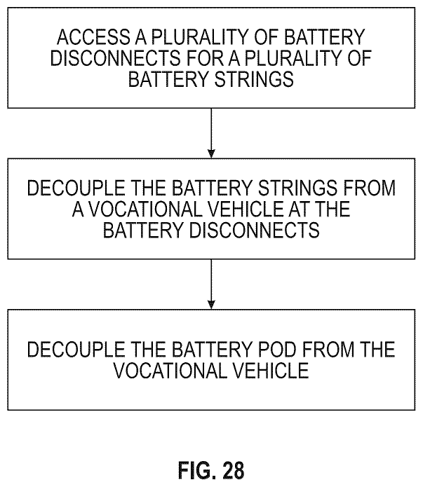

Referring to FIG. 28, a method 600 of servicing the battery pod, such as any of the battery pods described with reference to FIGS. 1-27 is shown, according to an exemplary embodiment. The method 600 includes accessing a battery disconnects for multiple battery strings of the battery pod by removing access panels disposed at opposing ends of each battery string, at 602. Operation 602 includes removing the access panels 264 from a shell of the battery pod. In some embodiments, operation 602 includes removing access panels 264 from opposing longitudinal ends of the shell and/or at opposing longitudinal ends of each battery cavity defined by the shell that enclose a respective one of the battery strings. In some embodiments, operation 602 includes removing access panels 264 disposed between and laterally outboard of a pair of frame rails of the vehicle chassis. In some embodiments, operation 602 includes removing bolts and/or another type of mechanical fastener securing the access panels 264 to the shell 208.

In some embodiments, the method 600 further includes decoupling the batteries from the vehicle at the battery disconnects to electrically isolate the battery system from the vehicle, at 604. In some embodiments, operation 604 includes disconnecting a battery disconnect for a first battery string of the plurality of battery strings to electrically isolate the first battery string from the vehicle independently from the remaining battery strings. Operation 604 may include repeating this operation for each battery string to fully electrically isolate the battery pack from the vehicle. In some embodiments, operation 604 also includes disconnecting cooling lines that extend from the battery pod to the vehicle, such as by uncoupling the cooling lines at fluid disconnects disposed proximate the battery disconnects.

In some embodiments, the method 600 also includes uncoupling (e.g., unfastening, etc.) the housing assembly (e.g., the shell of the battery pod) from the vehicle, at 606. Operation 606 may include disconnecting multiple mounts of the battery pod from the chassis and removing the battery pod from the chassis.

In some embodiments, the method 600 further includes servicing the batteries, and/or replacing the battery pod (e.g., with a second battery pod). In other embodiments, the method includes additional, fewer, and/or different operations.

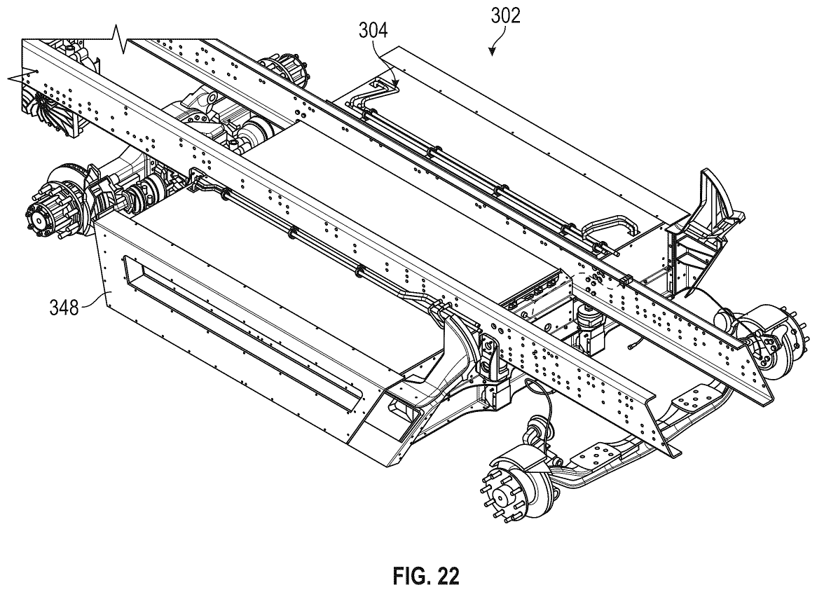

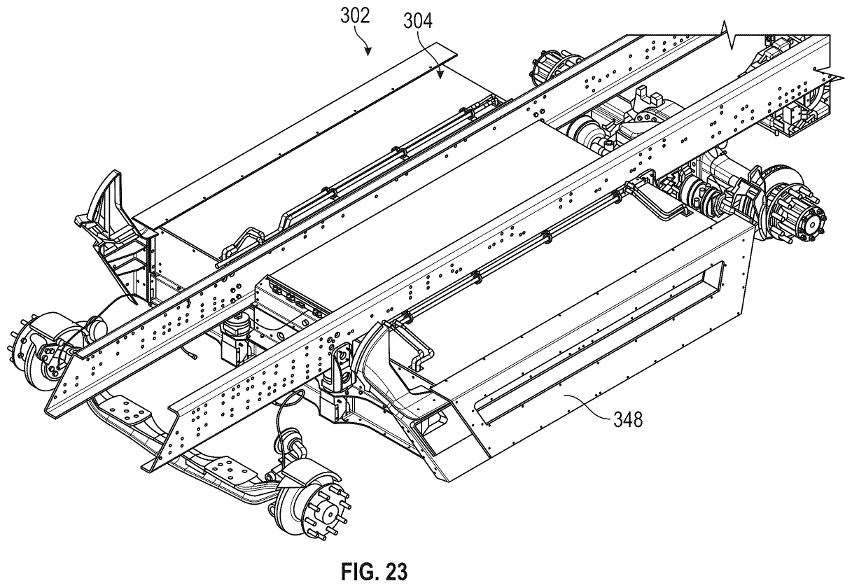

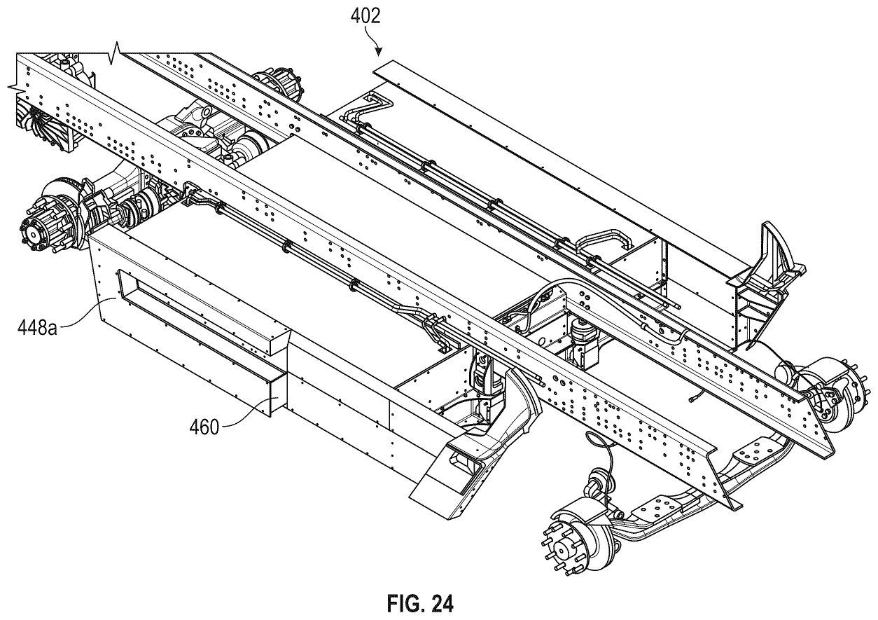

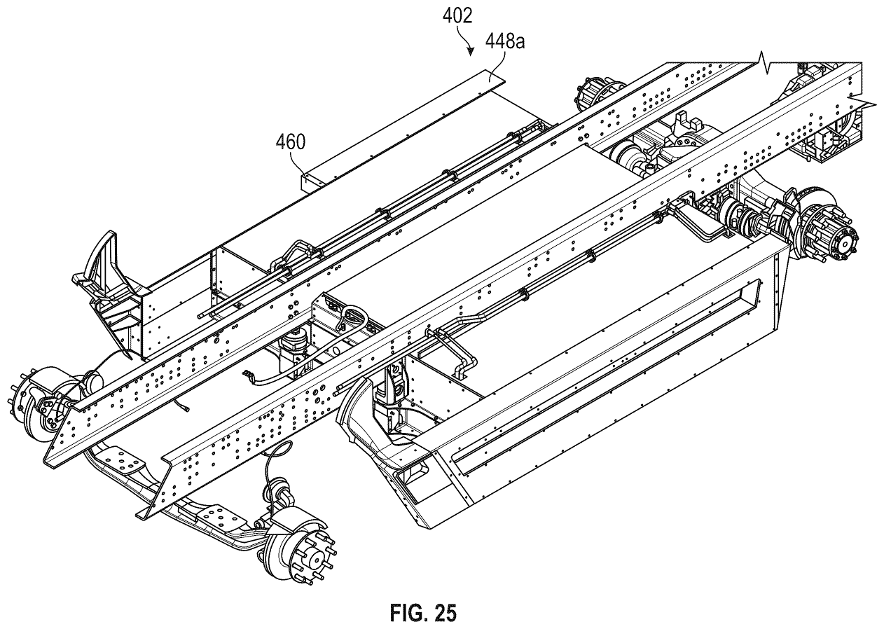

The design and arrangement of the battery pod 202 described with reference to FIGS. 1-21 should not be considered limiting, and it should be understood that various alterations may be possible without departing from the inventive principles disclosed herein. For example, referring to FIGS. 22-23, a battery pod 302 for a front-loading refuse vehicle is shown, according to an exemplary embodiment. The battery pod 302 includes side guards 348 on either side of a housing assembly 304 that extend across an entire length of the housing assembly 304. In other embodiments, the design of at least one of the side guards 348 may be different. For example, referring to FIGS. 24-25, another battery pod 402 for a refuse vehicle is shown in which one of the side guards, shown as a first side guard 448a defines an opening 460 along an intermediate portion of the housing assembly 404. The opening 460 may accommodate at least one vehicle component. For example, the first side guard 448a may be disposed on a curb side of a side-loading refuse vehicle and arranged so that at least a portion of the side-loading assembly may be positioned within the opening 460.

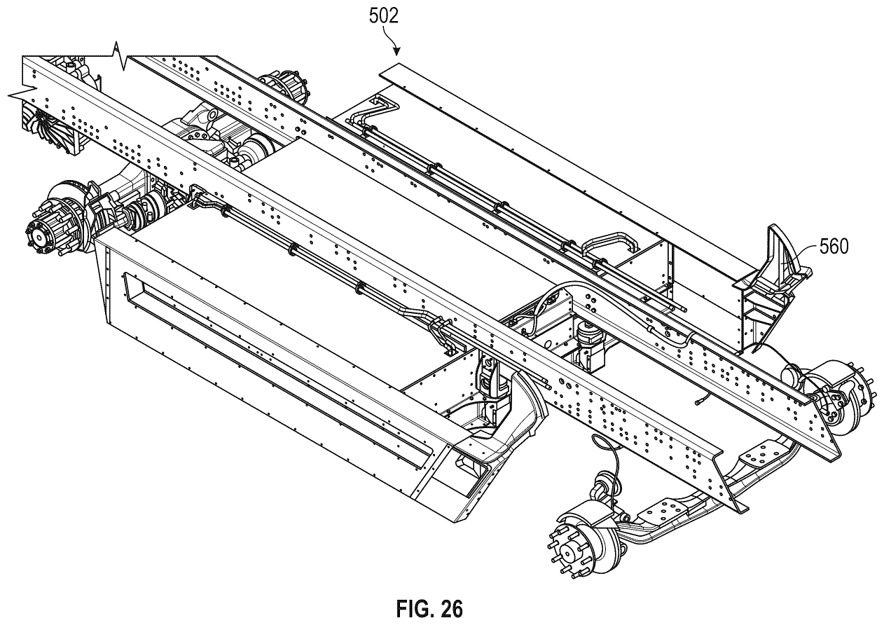

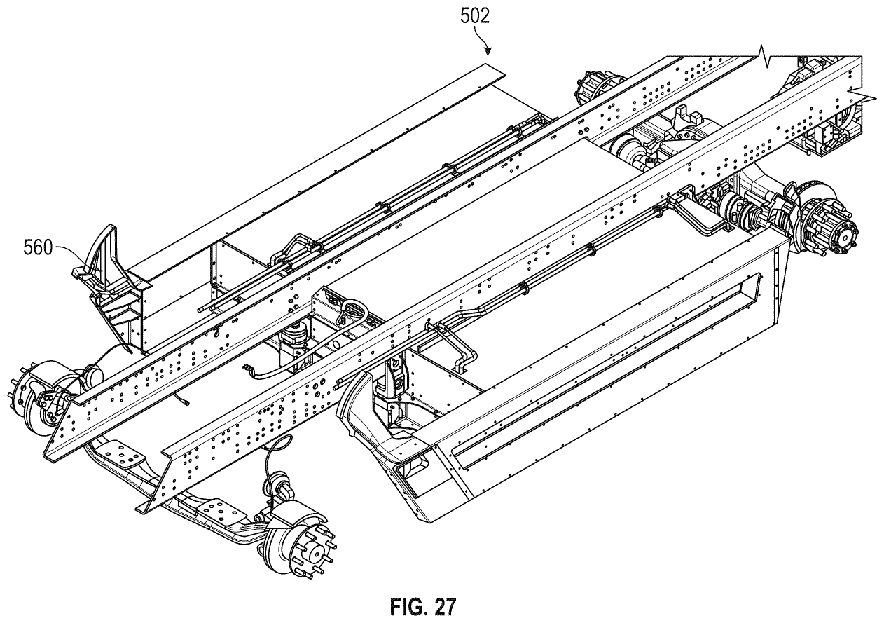

The dimensions of the battery pod may also be different in various embodiments. For example, referring to FIGS. 26-27, a battery pod 502 is shown that includes an extension 560 on either side of the vehicle chassis so as to accommodate chassis designs having a larger wheelbase. The extensions bridge or otherwise reduce a gap between side guards on either side of the battery pod 502 and the tractive elements, which can increase aerodynamic efficiency during transit.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vocational vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A vocational vehicle comprising:
a chassis supporting a plurality of tractive elements;
a vehicle body coupled to the chassis, the vehicle body comprising an application kit including a component that is movable relative to the chassis; and
a battery pod detachably coupled to the chassis and configured to provide power to at least one of the plurality of tractive elements or the application kit, the battery pod comprising:
a shell defining an interior cavity;
a plurality of batteries strings disposed within the interior cavity, the battery strings each comprising:
a plurality of batteries that are electrically coupled to one another; and
a battery disconnect coupling the plurality of batteries to the at least one of the plurality of tractive elements or the application kit; and
a plurality of access panels detachably coupled to the shell and providing access to respective ones of the battery disconnects.

2. The vocational vehicle of claim 1, wherein the chassis comprises a pair of frame rails extending in a longitudinal direction, wherein a first set of the plurality of access panels is disposed at a first longitudinal end of the shell, and a second set of the plurality of access panels is disposed at a second longitudinal end of the shell.

3. The vocational vehicle of claim 1, wherein the shell defines a plurality of battery cavities extending parallel to one another, wherein the access panels are disposed at opposing longitudinal ends of the battery cavities.

4. The vocational vehicle of claim 1, wherein the plurality of battery strings comprises three battery strings, the battery strings each including the plurality of batteries connected in series to one another.

5. The vocational vehicle of claim 1, wherein the battery disconnect for a first string of the plurality of battery strings is configured to electrically couple the first string to the at least one of a drive motor for the plurality of tractive elements or the application kit separately from remaining ones of the battery strings.

6. The vocational vehicle of claim 1, wherein the battery pod further includes a side panel coupled to the shell, the side panel and the shell together defining a conduit channel extending in a longitudinal direction between opposing ends of the shell.

7. The vocational vehicle of claim 6, wherein the shell defines a first access opening at a first longitudinal end of the conduit channel and a second access opening at a second longitudinal end of the conduit channel, wherein the first access opening and the second access opening extend from the conduit channel to the interior cavity.

8. The vocational vehicle of claim 1, wherein the battery pod further comprises cooling lines that are configured to transfer coolant across at least a portion of the battery pod, and wherein the access panels provide access to fluid disconnects for the cooling lines.

9. The vocational vehicle of claim 1, wherein the chassis comprises a pair of frame rails, wherein the access panels are disposed at opposing longitudinal ends of the shell and are oriented normal to the frame rails.

10. A battery pod comprising:
a shell defining an interior cavity, the shell defining a pair of recessed channels extending in a longitudinal direction, the pair of recessed channels sized to receive a pair of frame rails of a vehicle chassis;
a plurality of batteries strings disposed within the interior cavity and extending along the longitudinal direction, the battery strings each comprising:
a plurality of batteries that are electrically coupled to one another; and
a battery disconnect electrically coupled to plurality of batteries; and
a plurality of access panels detachably coupled to the shell and providing access to respective ones of the battery disconnects.

11. The battery pod of claim 10, wherein the access panels are disposed at opposing longitudinal ends of the shell.

12. The battery pod of claim 10, wherein the shell defines a plurality of battery cavities extending along the longitudinal direction, the battery strings disposed in respective ones of the battery cavities, wherein the access panels are disposed at opposing longitudinal ends of the battery cavities.

13. The battery pod of claim 10, wherein the access panels are spaced laterally apart from one another by the recessed channels.

14. The battery pod of claim 10, wherein the plurality of battery strings comprises three battery strings, the battery strings each including the plurality of batteries connected in series to one another.

15. The battery pod of claim 10, wherein the battery disconnect for a first string of the plurality of battery strings is configured to electrically couple the first string separately from remaining ones of the battery strings.

16. The battery pod of claim 10, wherein the battery pod further comprises cooling lines that are configured to transfer coolant across at least a portion of the battery pod, and wherein the access panels provide access to fluid disconnects for the cooling lines.

17. The battery pod of claim 10, wherein the access panels are disposed at opposing longitudinal ends of the shell and are oriented normal to the longitudinal direction.

18. A method of servicing a battery pod for a vocational vehicle, the method comprising:
accessing a plurality of battery disconnects for a plurality of battery strings by removing a plurality of access panels from ends of respective ones of the plurality of battery strings, the battery strings each including a plurality of batteries that are electrically coupled to one another;
electrically decoupling the battery strings from the vocational vehicle at the battery disconnects; and
decoupling the battery pod from the vocational vehicle.

19. The method of claim 18, wherein accessing the battery disconnects further comprises removing the plurality of access panels from a longitudinal end of a shell housing that encloses the battery strings.

20. The method of claim 18, wherein accessing the battery disconnects further comprises removing the access panels at locations between and laterally outboard of a pair of frame rails of the vocational vehicle.
